(19) United States
(12) Patent Application Publication
(10) Pub. No.: US 2003/0002183 A1
(43) Pub. Date: Jan. 2, 2003

(54) Head contact detector

(76) Inventor: Louis J. Fioravanti, Boulder, CO (US)

Correspondence Address: Mitchell K. McCarthy, Seagate Technology LLC, Intellectual Property - OKM280, 10321 West Reno, Oklahoma City, OK, 73127, US

(21) Appl. No.: 09/970,209

(22) Filed: Oct. 3, 2001

Related U.S. Application Data
(60) Provisional application No. 60/302,529, filed on Jul. 2, 2001.

(51) Int. Cl. G11B 5/02; G11B 15/04; G11B 21/02

(52) U.S. Cl. 360/25; 360/60; 360/75

(57) ABSTRACT

A contact detector for detecting intermittent contact between a read/write device and a data storage media during data reading and writing operations therebetween in a data storage device. The read/write device is supported upon a moveable support member responsive to a control system for moving the read/write device to selected positions adjacent the data storage media. The data storage media is supported by a motor responsive to the control system for spinning the data storage media to generate air currents that operatively lift and support the read/write device in spatial disposition from the data storage media. The contact detector comprises a receiver circuit comprising a sensor tuned to a selected frequency associated with the data storage device. The selected frequency indicates instances of the read/write device making contacting engagement with the data storage media. The contact detector furthermore comprises a control circuit responsive to the receiver circuit for adaptively controlling the data reading and writing operations of the read/write device and motor to protect stored data.

### CROSS REFERENCE TO RELATED APPLICATIONS

This application claims the benefit of U.S. Provisional Application No. 60/302,529.

### FIELD OF THE INVENTION

This invention relates generally to the field of data storage devices, and more particularly but not by way of limitation to an apparatus and associated method for protecting stored data by early detection of undesired contact of a read/write head with a respective data storage surface.

### BACKGROUND OF THE INVENTION

Modern data storage devices such as disc drives are commonly used in a multitude of computer environments to store large amounts of data in a form that is readily available to a user. Generally, a disc drive has a magnetic disc, or two or more stacked magnetic discs, that are rotated by a motor at high speeds. Each disc has a data storage surface divided into a series of generally concentric data tracks where data is stored in the form of magnetic flux transitions.

A data transfer member such as a magnetic transducer is moved by an actuator to selected positions adjacent the data storage surface to sense the magnetic flux transitions in reading data from the disc, and to transmit electrical signals to induce the magnetic flux transitions in writing data to the disc. The active elements of the data transfer member are supported by suspension structures extending from the actuator. The active elements are maintained a small distance above the data storage surface as the data transfer member flies upon an air bearing generated by air currents caused by the spinning discs.

A continuing trend in the industry is toward ever-increasing data storage capacity and processing speed while maintaining or reducing the physical size of the disc drive. Consequently, the data transfer member and supporting structures are continually being miniaturized, data storage densities are continually being increased, and data transfer member fly heights are continually being decreased. The result is an overall increased sensitivity to vibration and surface anomalies which can cause the data transfer member to contact the data storage surface. Such contacts can have an adverse effect on the data storage and retrieval capability of the disc drive.

It has been determined that by strategically placing a tuned acoustic emissions sensor on the device supporting the data transfer member that intermittent contacts can be detected and used to signal preventive measures to maximize the likelihood that stored data is preserved. It has further been determined that by employing two or more such tuned sensors that the location of the contacts can be identified in a disc stack so that the preventive measures can be limited to only where they are needed. It is to these improvements and others as exemplified by the description and appended claims that embodiments of the present invention are directed.

### SUMMARY OF THE INVENTION

Embodiments of the present invention are directed to a contact detector for detecting contact between a read/write device and a data storage media during data reading and writing operations therebetween in a data storage device. The read/write device is supported upon a moveable support member responsive to a control system for moving the read/write device to selected positions adjacent the data storage media. The data storage media is supported by a motor responsive to the control system for spinning the data storage media to generate air currents that operatively lift and support the read/write device in spatial disposition from the data storage media.

The contact detector comprises a receiver circuit comprising a sensor tuned to a selected frequency associated with the data storage device. Acoustic emissions within the selected frequency indicate instances of the read/write device making contacting engagement with the data storage media. The contact detector furthermore comprises a control circuit responsive to the receiver circuit for adaptively controlling the data reading and writing operations of the read/write device and motor to protect stored data.

In one embodiment the contact detector has a selected frequency comprising a frequency associated with a resonance frequency of the data storage device, such as the resonant frequency of the slider portion of the read/write head.

In one embodiment the receiver circuit comprises a sensor connected to a unitary portion of a supporting structure and is thereby substantially equally responsive to acoustic emissions propagating from any of a plurality of the heads. Alternatively, the receiver circuit comprises two or more sensors connected to individual supporting arms associated with respective heads, which are thereby substantially more receptive of acoustic emissions propagating from the head supported by the respective arm. Where the receiver circuit comprises two or more sensors, a differential amplitude signal from the sensors can indicate which sensor is closer to the head making contact. With such pinpointing determination of the location of the head contact, data protection measures such as back-up reading operations can be limited to the head or heads making contact.

In another aspect the embodiments of the present invention contemplate a method for detecting contacting engagement between a read/write device and an associated data storage media in a data storage device. The method comprises a step of providing a receiver circuit comprising an acoustic emission sensor tuned to detect a selected frequency and responsively provide a signal indicating the contacting engagement. The method further comprises the step of supporting the sensor on a support member that also supports the read/write device. The method further comprises the step of monitoring the sensor to detect acoustic emissions at the selected frequency. The method further comprises the step of initiating data protection measures in response to receiving the signal from the sensor.

In another aspect the embodiments of the present invention contemplate a disc drive, comprising a read/write device in an operative data reading and writing relationship with a spinning data storage disc, and means for protecting stored data by invoking data protection measures in response to detecting acoustic emissions indicative of intermittent contact between the read/write device and the disc.

These and various other features as well as advantages which characterize the present invention will be apparent upon reading of the following detailed description and review of the associated drawings.

### BRIEF DESCRIPTION OF THE DRAWINGS

FIG. 1 is a plan view of a data storage device constructed in accordance with an embodiment of the present invention.

FIG. 2 is a diagrammatic elevational view of one of the read/write heads of the disc drive of FIG. 1 flying spatially disposed away from the data storage surface upon air currents generated by the spinning data discs.

FIG. 3 is a diagrammatic elevational view similar to FIG. 2 but illustrating a contacting engagement between the read/write head and the data storage surface during the data transfer operations.

FIG. 4 is a functional block diagram of the disc drive of FIG. 1 operably connected to a host computer.

FIG. 5 is an isometric illustration of a portion of the actuator of the disc drive of FIG. 1.

FIG. 6 is a partial cross sectional view of a portion of the disc drive of FIG. 1 illustrating the interleaved relationship of the actuator arms and the data storage discs.

FIG. 7 is an enlarged detail view of a portion of the disc drive of FIG. 6 diagrammatically showing a sensor supported by the central body of the actuator in accordance with an embodiment of the present invention.

FIG. 8 is an enlarged detail view similar to FIG. 7 but diagrammatically showing two sensors supported by two of the actuator arms in accordance with an embodiment of the present invention.

FIG. 9 is a diagrammatic block diagram of the receiver circuit of FIG. 4 further comprising a differential amplitude comparator circuit to indicate which, if any, of the sensors that are resonating at the selected frequency are closer to the head making contact.

FIG. 10 is an enlarged detail view similar to FIG. 7 but diagrammatically showing sensors supported by each of the actuator arms in accordance with an embodiment of the present invention.

FIG. 11 is a block diagram of a method comprising steps in accordance with an embodiment of the present invention.

### DETAILED DESCRIPTION

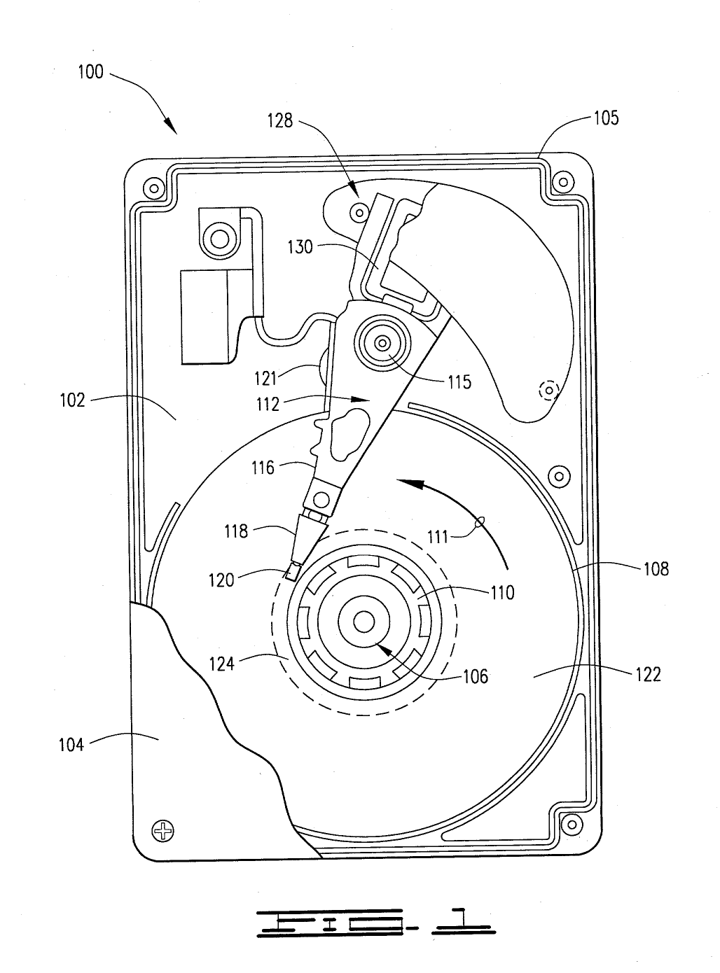

Referring to the drawings in general, and more particularly to FIG. 1, shown therein is a plan representation of a data storage disc drive 100 constructed in accordance with an embodiment of the present invention. The disc drive 100 includes a base 102 to which various disc drive components are mounted, and a cover 104 (partially cut-away) which together with the base 102 and a perimeter gasket 105 form an enclosure providing a sealed internal environment for the disc drive 100. Numerous details of construction are not included in the following description because they are well known to a skilled artisan and are unnecessary for an understanding of the present invention.

Mounted to the base 102 is a motor 106 to which one or more discs 108 are stacked and secured by a clamp ring 110 for rotation at a high speed in direction 111. Where a plurality of discs 108 are stacked to form a disc stack, adjacent discs 108 are typically separated by a disc spacer (not shown). An actuator 112 pivots around a pivot bearing 115 in a plane parallel to the discs 108. The actuator 112 has actuator arms 116 (only one shown in FIG. 1) that support load arms 118 in travel across the discs 108 as the actuator arms 116 move within the spaces between adjacent discs 108. The load arms 118 (or “flexures”) are flex members that support data transfer members, such as read/write heads 120 (“heads”), with each of the heads 120 operatively interfacing one of the discs 108 in a data reading and writing relationship. This relationship is maintained by a slider (see below) having an aerodynamic surface which operably supports the head 120 on an air bearing sustained by air currents generated by the spinning discs 108. Data read and write signals are transmitted from the head 120 to a preamplifier 121 by electrical traces (not shown) extending along the actuator 112.

Each of the discs 108 has a data storage region comprising a data storage surface 122 divided into concentric circular data tracks (not shown). Each of the heads 120 is positioned adjacent a desired data track to read data from or write data to the data track. The data storage surface 122 can be bounded inwardly by a circular landing zone 124 where the heads 120 can come to rest against the respective discs 108 at times when the discs 108 are not spinning. Alternatively, the landing zone can be located elsewhere.

The actuator 112 is positioned by a voice coil motor (VCM) 128 comprising an electrical coil 130 and a magnetic circuit source. The magnetic circuit source conventionally comprises one or more magnets supported by magnetic poles to complete the magnetic circuit. When controlled current is passed through the actuator coil 130, an electromagnetic field is set up which interacts with the magnetic circuit causing the actuator coil 130 to move. As the actuator coil 130 moves, the actuator 112 pivots around the pivot bearing 115, causing the heads 120 to travel across the discs 108.

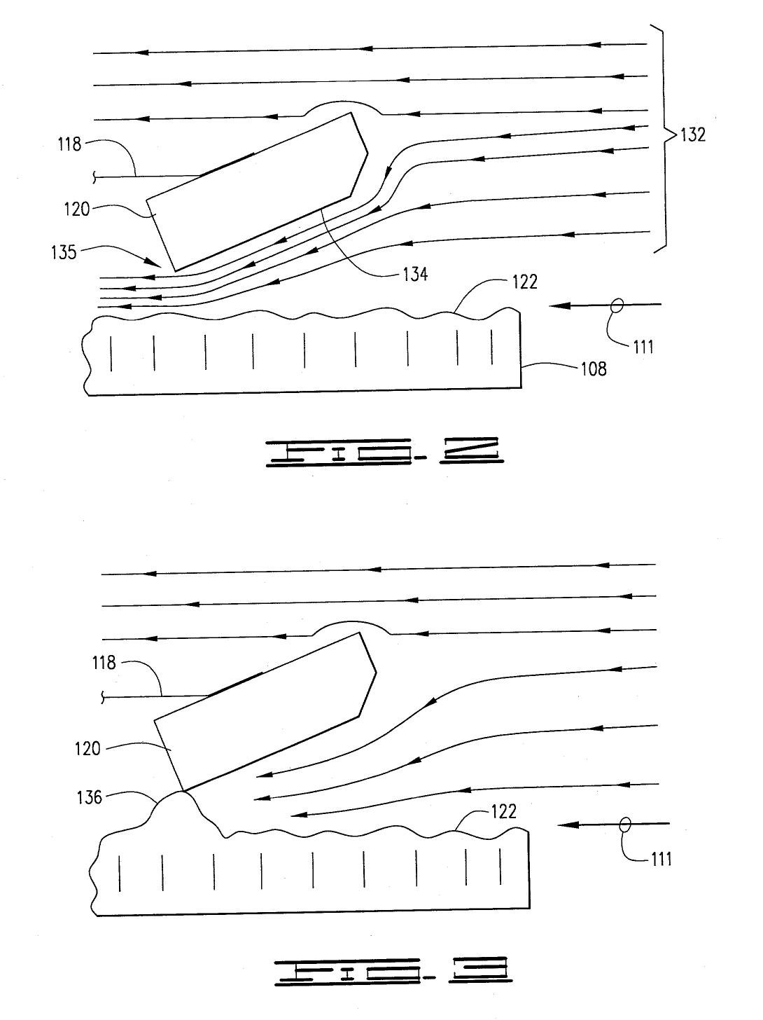

The motor 106 spins the discs 108 at a high speed as the head 120 reads data from and writes data to the data storage surface 122. The kinetic energy of the spinning discs 108 transfers through the boundary layer at the disc/air interface, thereby inducing a rotational force component to air currents, and centrifugal force imparts a radial force component to air currents, creating a generally outwardly spiraling airstream. FIG. 2 is a diagrammatic elevational view of one of the read/write heads 120 flying spatially disposed from the data storage surface 122 upon a portion of the air currents 132 that engage against an air bearing surface 134 (“slider”) of the head 120. The aerodynamic characteristics of the slider 134 and the velocity of the spinning discs 108 are some of the factors considered in order to operatively fly the head 120 in a desired spatial disposition from the data storage surface, separated therefrom by a desired gap 135.

FIG. 3 is a view similar to FIG. 2 but showing the head 120 contacting an anomaly 136 in the gap 135. The anomaly can be a portion of the data storage media that accumulated or was created by a previous contacting engagement during manufacturing or operation. The anomaly can also be debris such as a dust particle or a smudge. The contact shown in FIG. 3 is characteristic of the type referred to commonly as an intermittent contact; that is, in and of itself likely not a failure condition because the damage to the data storage media, if any, is likely localized to the anomaly. These intermittent contacts are difficult to detect, because they are not generally associated with measureable deflections or oscillations of the read/write head 120 relative to the gap 135. Left unchecked, however, the intermittent contacts can progressively worsen, especially if head slaps result as the head 120 continues to be deflected upwardly from a contact and back downwardly by the flexure 118. Embodiments of the present invention provide early detection of these intermittent contacts to prevent them from progressively resulting in a head crash.

The contacting engagement such as in FIG. 3 creates high frequency acoustic waves that propagate within the physical lattice of the structural material. In this case, the acoustic waves propagate within the head 120 and the supporting actuator 112, including the flexure 118 and the actuator arms 116. These acoustic waves are of a relatively high frequency, beyond the capability of an accelerometer sensing device. Typically, the frequencies are within the range of 1 to 2 Mhz, which are detectable by a piezoelectric (“pzt”) sensing device. Embodiments of the present invention comprise a contact detector comprising a receiver circuit and a control circuit responsive to the receiver circuit for adaptively controlling the data reading and writing operations of the head 120 and motor 106 to protect stored data in the event of intermittent contact. The receiver circuit in one embodiment comprises a pzt sensor employed as an acoustic emissions (AE) sensor that is tuned to a frequency associated with operations of the disc drive 100.

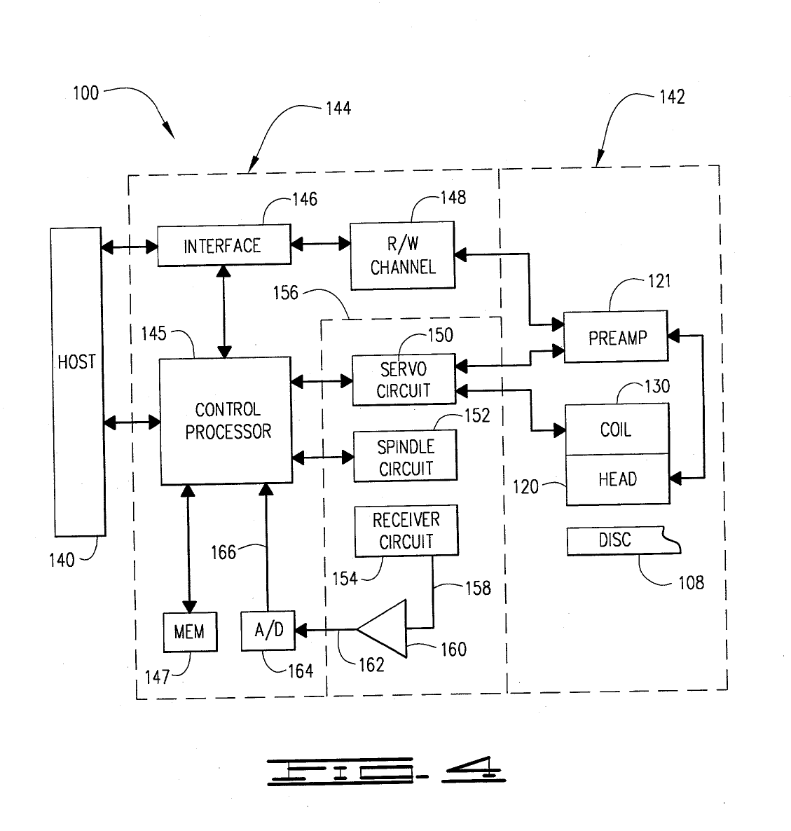

FIG. 4 is a block diagram of the disc drive 100 of FIG. 1 operably coupled to a host computer 140. The functional circuits are grouped to illustrate the disc drive 100 comprising a head disc assembly (HDA) 142 which generally comprises the mechanical components shown in FIG. 1. A contact detector is represented generally by reference number 144

The contact detector 144 has control processor 145 providing top level control of the operation of the disc drive 100. Programming and information utilized by the control processor 145 are provided in memory device 147, including a dynamic random access member (DRAM) device and a flash member device. The memory device structure can vary depending upon the requirements of a particular application of the disc drive 100.

An interface circuit 146 includes a data buffer and a sequencer for directing the operation of the disc drive 100 during data transfer operations. Generally, during a data write operation a read/write channel 148 encodes data to be written to the disc 108 with run-length limited (RLL) and error correction codes (ECC) and write currents corresponding to the encoded data are applied by the preamp driver circuit 121 to the read/write head 120 in order to selectively magnetize the disc 108. During a data read operation, the preamp driver circuit 121 applies a read bias current to the head 120 and monitors the voltage across a magneto-resistive (MR) element of the head 120, which varies according to the selective magnetization of the disc 108. The voltage is preamplified by the preamp driver circuit 121 to provide a read signal to the read/write channel 148 which decodes the stored data and provides the same to the buffer of the interface circuit 146, for subsequent transfer to the host computer 140.

A servo circuit 150 controls the position of the head 120 through servo information read by the head 120 and provided to the servo circuit 150 by way of the preamp driver 121. The servo information indicates the relative position of the head 120 with respect to a selected track on the disc 108. In response to the servo information, a digital signal processor controls the application of the current to the coil 130 in order to adjust the position of the head 120 to a desired location. A spindle circuit 152 controls the rotation of the discs 108 through back electromagnetic force (bemf) commutation of the spindle motor 106.

A receiver circuit 154 is integrated into a control circuit 156 in an application specific integrated circuit (ASIC) which comprises at least portions of the servo circuit 150 and the spindle circuit 152, to detect intermittent contacts of the head 120 with the disc 108 and to responsively control the data reading and writing operations to protect stored data. Generally, the receiver circuit 154 comprises a pzt sensor outputting an analog acoustic emissions measurement on signal path 158 to a driver circuit 160 which amplifies the acoustic emissions signal and provides the same on signal path 162 to an analog to digital (A/D) converter 164 operably coupled to the control processor 145 by signal path 166, so that the control processor 145 has access to a digital representation of the acoustic emissions signal provided by the receiver circuit 154.

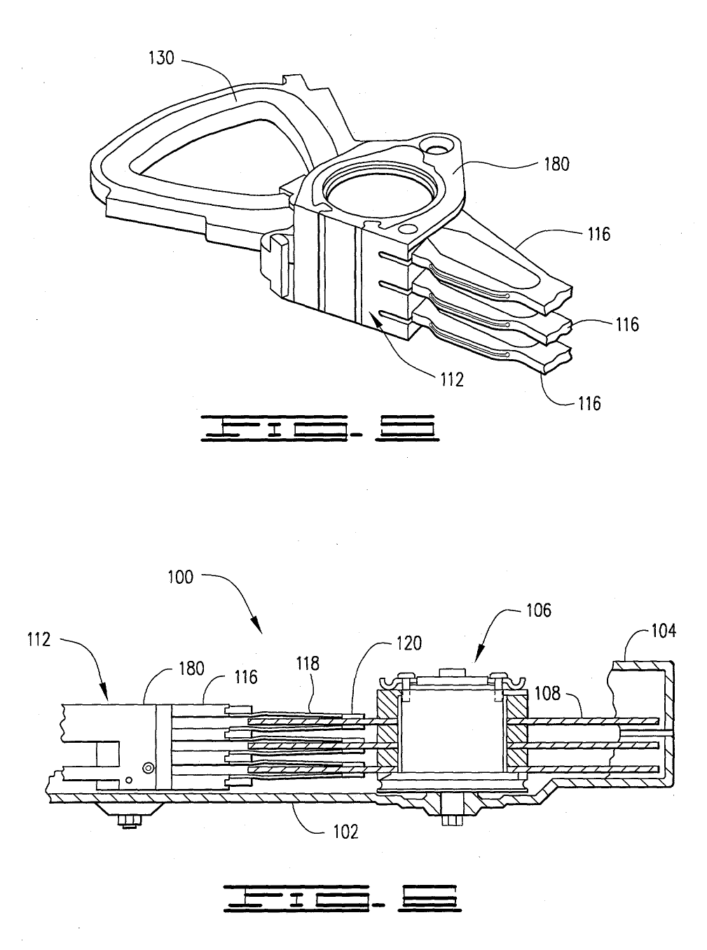

The receiver circuit 154 can be arranged to detect a head 120 contact event generally, or can be arranged to alternatively pinpoint the location of the head 120 contact event. Turning briefly to FIG. 5 which is an isometric illustration of a portion of the actuator 112 of the disc drive 100 (FIG. 1). The actuator 112 comprises a unitary body portion 180 interposed between the coil 130 and the arms 116 extending oppositely therefrom. As best shown in FIGS. 5 and 6, the arms 116 are interleaved with the discs 108 to position the read/write heads 120. Accordingly, head 120 contact events between a particular head 120 creates high frequency acoustic emissions within the respective supporting flexure 118 and arm 116. Because all the arms 116 are unitarily joined to the body 180, the acoustic emissions generated by contact of any of the plurality of heads 120 propagate within the body 180.

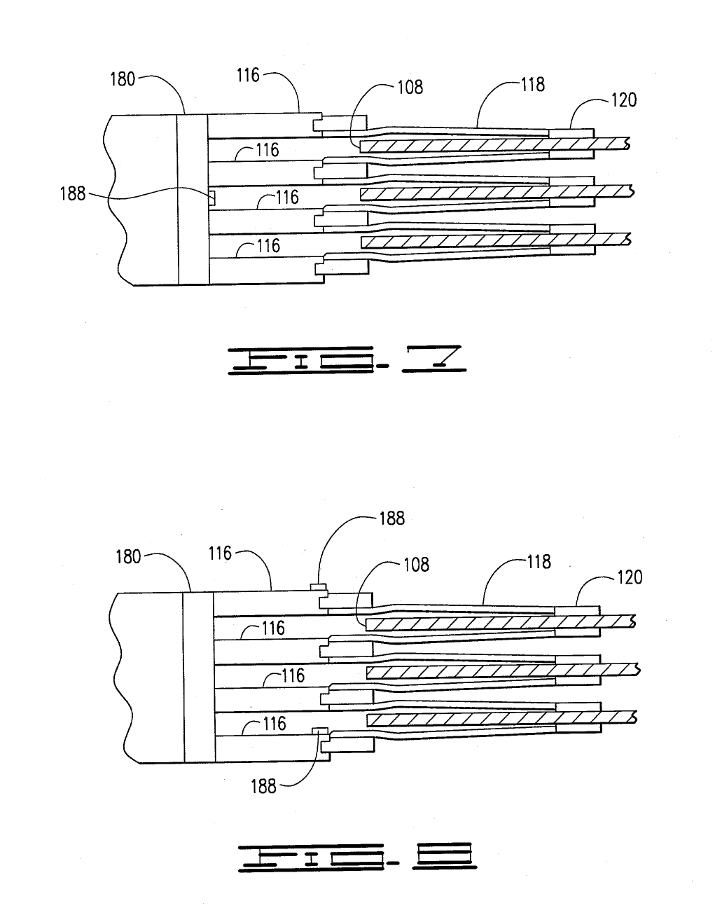

FIG. 7 diagrammatically illustrates a portion of a receiver circuit 154 (FIG. 3) comprising a pzt sensor 188 attached to the upstanding portion of the body 180 between adjacent arms 116. In this manner, the sensor 188 will detect acoustic emissions of a selected frequency propagating within the body 180 from any of the plurality of heads 120. The sensor 188 can be attached at other locations on the body 180 in equivalent alternative embodiments.

The pzt sensor is customized to resonate at a selected frequency associated with the disc drive 100. For example, a particular disc drive can be observed to have a slider resonance of 2 Mhz. It has been determined that a pzt wafer can be produced with a 2 Mhz resonance at about 0.035 inches thick, and can be adaptively sized to fit on the actuator 112 in a manner described above. By tuning the pzt sensor to a particular resonant frequency, and matching that particular frequency with a resonant frequency of the slider 134, then spurious frequencies are of negligible effect on the receiver circuit 154. Furthermore, complex filtering of the receiver circuit 154 output is unnecessary, unlike the use of a sensor receptive to a frequency range.

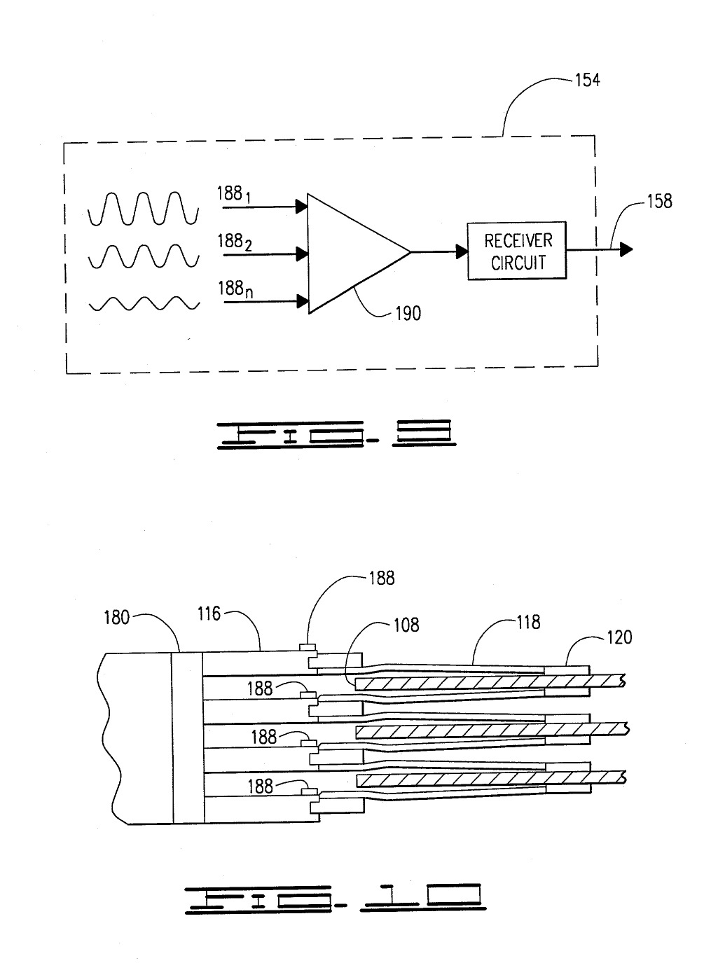

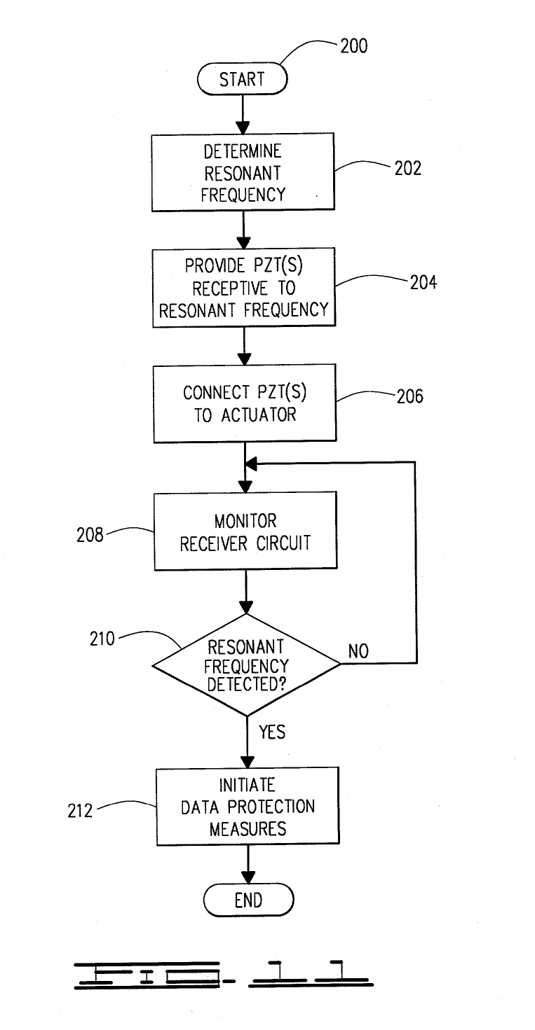

FIG. 8 is a view similar to FIG. 7 but wherein the receiver circuit 154 comprises two sensors 188 attached to individual arms 116 and thereby substantially more receptive of acoustic emissions generated from contact of the head 120 depending from the respective arm 116. FIG. 9 diagrammatically shows the receiver circuit 154 comprising a comparator circuit 190 for indicating which, if any, of a plurality of sensors 188 are resonating at the selected frequency, and comparing the relative signal amplitude from the sensors 188. By monitoring a differential amplitude of the AE signals from the sensors 188, information about the location of the head 120 making contact can be discerned. To pinpoint the location of the head 120 contact even more, FIG. 10 illustrates an embodiment wherein the receiver circuit 154 comprises a sensor on each of the plurality of arms 116. By knowing which head(s) 120 are making contact preventive measures such as backing up stored data can be limited to only the head(s) which are indicating contact has been made.

One aspect of the embodiments of the present invention comprises a method for detecting contacting engagement between a read/write device and an associated data storage media in a data storage device. FIG. 10 illustrates a method in accordance with an embodiment of the present invention beginning at block 200. At block 202 a frequency is selected for indicating a head 120 contact. As discussed above, in one embodiment it is advantageous to determine and select the resonance frequency of the slider 134 so as to effectively rule out spurious frequencies. At block 204 one or more pzt(s) are provided that are tuned to resonate at the selected frequency from block 202. At block 206 the pzt(s) are connected to the actuator in a desired arrangement to provide the corresponding receiver circuit 154 output. For example, in one embodiment one pzt can be connected to the body 180 of the actuator 112 so as to be substantially equally receptive to acoustic emissions from any of the heads 120 making contact. Alternatively, the pzt(s) can be connected to one or more arms 116 of the actuator 112 so as to be substantially more receptive to acoustic emissions from the respective head 120 supported by that particular arm 116. Where two or more pzts are arranged in such a manner a differential amplitude signal can be monitored to determine which of the pzts are closer to the head 120 making contact.

In block 208 the control processor 145 (FIG. 4) issues commands upon start-up and operation of the disc drive 100 to monitor the output signal 166 from the receiver circuit 154 comprising the pzts selected and arranged in accordance with blocks 202-206. In decision block 210 the control processor 145 initiates data protection measures in block 212 upon detecting a signal from the receiver circuit 154 that a head contact 120 has occurred.

The data protection measures in block 212 can range from marking and recording the instances of a head 120 contact to backing up data and shutting down the disc drive 100 to prevent an imminent head crash. These more stringent latter protective measures can be implemented upon accumulation of a selected number of head 120 contacts to reduce the occasion of nuisance warnings or shut downs.

In summary, a contact detector (such as 144) monitors the instances of intermittent read/write head (such as 120) contacts to preventatively take data protection measures in a data storage device.

The contact detector comprises a receiver circuit (such as 154) including one or more piezoelectric sensors (such as 188) that are tuned to be receptive to a selected frequency of acoustic emissions. Preferably, the selected frequency is associated with an operating characteristic of the data storage device, such as the resonant frequency of the slider (such as 134) portion of the head to eliminate effects of spurious frequencies.

The sensors are connected to a supporting structure such as an actuator (such as 112). The sensors can be arranged on a unitary portion of the supporting structure (such as 180) to be substantially equally receptive to acoustic emissions from all of the heads, or can be arranged on individual supporting arms (such as 116) to be substantially more receptive to acoustic emissions from the head supported by the particular arm. Where two or more sensors are connected to the supporting structure, a differential amplitude signal can be monitored to determine which of the sensors is closer to the head making contact, thus pinpointing the problem.

The contact detector furthermore comprises a control circuit (such as 156) in the form of an application specific integrated circuit that is responsive to the receiver circuit for adaptively controlling the data reading and writing operations of the head and spindle motor to protect stored data.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the fall extent indicated by the broad general meaning of the terms in which the appended claims are expressed. For example, the selected frequency at which to tune the receiver circuit may vary while maintaining substantially the same functionality without departing from the scope and spirit of the present invention. In addition, although the preferred embodiment described herein is directed to a data storage device, it will be appreciated by those skilled in the art that the teachings of the present invention can be applied to other systems, like data storage test or certification systems, servo track writers, or optical data storage systems, without departing from the scope and spirit of the present invention.

What is claimed is:

1. A contact detector for detecting contact between a read/write device and a data storage media during data reading and writing operations therebetween in a data storage device, the read/write device supported upon a moveable support member responsive to a control system for moving the read/write device to selected positions adjacent the data storage media, the data storage media supported by a motor responsive to the control system for spinning the data storage media to generate air currents that operatively lift and support the read/write device in spatial disposition from the data storage media, the contact detector comprising:
a receiver circuit comprising a sensor tuned to a selected frequency associated with the data storage device, indicating the read/write device is making a contacting engagement with the data storage media;
a control circuit responsive to the receiver circuit for adaptively controlling the data reading and writing operations of the read/write device and motor to protect stored data.

2. The contact detector of claim 1 wherein the selected frequency comprises a frequency associated with a resonance frequency of the data storage device.

3. The contact detector of claim 1 wherein the sensor comprises a sensor characteristic of the type comprising a piezoelectric sensor.

4. The contact detector of claim 1 wherein the support member comprises an actuator with a unitary body and two or more arms extending from the body, each arm supporting a read/write device adjacent the respective data storage media, wherein the receiver circuit comprises a sensor supported by the body and thereby receptive of acoustic emissions generated from contact between any of the read/write devices and the respective data storage media.

5. The contact detector of claim 1 wherein the support member comprises an actuator with a unitary body and two or more arms extending from the body, each arm supporting a read/write device adjacent the respective data storage media, wherein the receiver circuit comprises a sensor supported by at least one of the arms and thereby substantially more receptive of acoustic emissions generated from contact between the respective read/write head and data storage media.

6. The contact detector of claim 5 wherein the receiver comprises a sensor supported by each of two or more of the arms.

7. The contact detector of claim 6 wherein the receiver circuit comprises a differential signal indicating which of the two or more sensors is closer to the read/write head making contacting engagement with the data storage media.

8. The contact detector of claim 6 wherein the receiver circuit comprises a sensor supported by each of the arms.

9. A method for detecting contacting engagement between a read/write device and an associated data storage media in a data storage device, comprising:
providing a receiver circuit comprising an acoustic emission sensor tuned to detect a selected frequency and responsively provide a signal indicating the contacting engagement;
connecting the sensor to a support member that supports the read/write device;
monitoring the sensor to detect acoustic emissions at the selected frequency; and
initiating data protection measures in response to receiving the signal from the sensor.

10. The method for detecting of claim 9 wherein the providing a receiver circuit element comprises providing a sensor with a selected frequency associated with a resonance frequency of the data storage device.

11. The method for detecting of claim 9 wherein the providing a receiver circuit element comprises providing a sensor characteristic of the type comprising a piezoelectric sensor.

12. The method for detecting of claim 9 wherein the data storage device comprises two or more read/write devices and a support member supporting the read/write devices, the support member comprising an actuator with a unitary body and two or more arms extending from the body, each arm supporting a read/write device adjacent the respective data storage media, wherein the connecting the sensor element comprises connecting the sensor to the body to responsively detect acoustic emissions generated from contact between any of the read/write devices and the respective data storage media.

13. The method for detecting of claim 9 wherein the data storage device comprises two or more read/write devices and a support member supporting the read/write devices, the support member comprising an actuator with a unitary body and two or more arms extending from the body, each arm supporting a read/write device adjacent the respective data storage media, wherein the connecting the sensor element comprises connecting the sensor to at least one of the arms to responsively detect acoustic emissions generated from contact between the respective read/write devices and the respective data storage media.

14. The method for detecting of claim 13 wherein the connecting the sensor element of claim 12 comprises connecting a sensor to each of two or more of the arms.

15. The method for detecting of claim 14 wherein the monitoring the sensor element comprises a differential comparison of the sensors indicating which of the sensors is closer to the read/write device making contacting engagement with the data storage media.

16. The method for detecting of claim 14 wherein the connecting the sensor element of claim 13 comprises connecting a sensor to each of the arms.

17. The method for detecting of claim 9 wherein the initiating data protection element comprises saving data to memory.

18. The method for detecting of claim 9 wherein the initiating data protection element comprises signaling a warning.

19. The method for detecting of claim 9 wherein the initiating data protection element comprises powering down the disc drive.

20. A disc drive, comprising:
a read/write device in an operative data reading and writing relationship with a spinning data storage disc; and
means for protecting stored data by invoking data protection measures in response to detecting acoustic emissions indicative of contact between the read/write device and the disc.

21. The disc drive of claim 20 wherein the means for protecting comprises invoking data protection measures in response to acoustic emissions associated with a resonance frequency of the data storage device.

22. The disc drive of claim 20 wherein the means for protecting comprises an acoustic emissions sensor characteristic of the type comprising a piezoelectric sensor.

23. The disc drive of claim 20 comprising a support member operatively supporting the read/write device in the data reading and writing relationship with the disc, the support member comprising an actuator with a unitary body and two or more arms extending from the body, each arm supporting a read/write head adjacent the respective data storage disc, wherein the means for protecting comprises connecting the sensor to the body to responsively detect acoustic emissions generated from contact between any of the read/write devices and the respective data storage disc.

24. The disc drive of claim 23 wherein the means for protecting further comprises at least one sensor supported by at least one of the arms.

25. The disc drive of claim 24 wherein the means for protecting comprises a plurality of sensors, each supported by one of the arms.

26. The contact detector of claim 25 wherein the means for protecting comprises a sensor supported by each of the arms.

27. The contact detector of claim 25 wherein the means for protecting comprises a differential signal from the plurality of sensors indicating which of the sensors is closer to the read/write head contacting engagement.
